(19) United States
(12) Patent Application Publication
(10) Pub. No.: US 2018/0082313 A1
(43) Pub. Date: Mar. 22, 2018

(54) SYSTEMS AND METHODS FOR PRIORITIZING USER REACTIONS TO CONTENT FOR RESPONSE ON A SOCIAL-MEDIA PLATFORM

(71) Applicant: MyChannel Inc., Chalfont, PA (US)

(72) Inventors: Julian Vincent Duggin, Philadelphia, PA (US); Gibran Kahlil Gadsden, Philadelphia, PA (US); Rosie Mercedes Salcedo, Menlo Park, CA (US)

(73) Assignee: MyChannel Inc.

(21) Appl. No.: 15/712,827

(22) Filed: Sep. 22, 2017

Related U.S. Application Data
(60) Provisional application No. 62/398,302, filed on Sep. 22, 2016.

(51) Int. Cl. G06Q 30/02; G06Q 50/00; G06N 99/00

(52) U.S. Cl. CPC G06Q 30/0201; G06N 99/005; G06Q 50/01

(57) ABSTRACT

Systems and methods are described herein for prioritizing user reactions to content on a social-media platform. The systems and methods receive, from a channel administrator, weighting preferences used to determine weights assigned to user reactions and receive reaction data associated with content. The reaction data represents user reactions to the content. The systems and methods generate a sentiment metric associated with reaction data and representing the degree to which a user reaction is positive or negative, and generate a weight associated with reaction data based on the sentiment metric and weighting preferences. The systems and methods prioritize the user reaction with respect to other user reactions to the associated content based on the weight and provide an interface for responding to the user reaction.

### BACKGROUND

### Priority

This application claims priority under 35 U.S.C. §119 to United States Provisional Patent Application No. 62/398,302, filed on Sep. 22, 2016, which is herein incorporated in its entirety by reference.

### TECHNICAL FIELD

The present disclosure relates generally to systems and methods for prioritizing user reactions to content for response on a social-media platform.

### BACKGROUND

Social-media content providers want to share their content with others. Social-media platforms, such as web-application social-media platforms, may be used to give users of the platforms access to the shared content. Users viewing the shared content may have reactions to the viewed content and may express those reactions by posting to the social-media platform. These reactions can be provided in various formats, such as audio, text, or video. A platform capable of receiving reactions in various formats may be described as a multimodal platform. Content providers may want to be able to respond to users' reactions on the platform and/or gather data on users' reactions to the shared content. Content providers may want to know, for example, how users feel about the shared content, what portion of the content made users feel a particular way, or how to motivate users to view their content. Content providers may want to know which reactions they should respond to in order to achieve their goals. For example, content providers may want to comment on reactions that mention a particular topic in order to influence what the public thinks about this topic.

The disclosed methods and systems are directed to overcoming one or more of the problems set forth above and/or other problems or shortcomings in the prior art.

### BRIEF DESCRIPTION OF DRAWINGS

The accompanying drawings, which are incorporated in and constitute a part of this specification, illustrate the disclosed embodiments and, together with the description, serve to explain the principles of the various aspects of the disclosed embodiments. In the drawings:

FIG. 1 illustrates a system environment in which a multimodal social-media data analytics-and-engagement platform may be implemented;

FIG. 2 illustrates an example of a data-flow diagram demonstrating the operation of an analytics engine;

FIG. 3 illustrates an example of an analytics sub-engine and its operation;

FIG. 4 illustrates an example of an output dashboard;

FIG. 5 illustrates an example of a reaction graph; and

FIG. 6 illustrates an example of a method for prioritizing user reactions to content for response on a social-media platform.

It is to be understood that both the foregoing general description and the following detailed description are exemplary and explanatory only and are not restrictive of the claims.

### DESCRIPTION OF EXEMPLARY EMBODIMENTS

A multimodal social-media data analytics and engagement platform may be used to capture multimodal sentiment information. For example, the platform may assign a weight to the social-media data based on a combination of video, audio, or text-message data received from user interactions and the sentiments associated with these interactions. The multimodal social-media data analytics and engagement platform may be a web-based application that allows users to share information through a social-media network that uses video, audio, text, and other modes of communication to share content and reactions thereto with a social network.

Systems and methods are described to collect, analyze, and report multimodal sentiment and behaviors on a social-media data analytics and engagement platform where the data is aggregated from a plurality of data sources such as, but not limited to video, audio, text data, and other electronic sources. One method may comprise determining the sentiment and/or behavior of a user on a multimodal social-media data analytics and engagement platform. The resulting multimodal analysis may be categorized into clusters by demographics, sentiment patterns, behavior patterns, and interest groups. These attributes may be inputted into a predictive model to determine patterns in sentiment and behavior.

The features and advantages described in the specification are not all-inclusive and many additional features and advantages will be apparent to one of ordinary skill in the art in view of the figures, specification, and claims. Moreover, it should be noted that the language used in the specification has been principally selected for readability and instructional purposes, and may not have been selected to delineate or circumscribe the claimed subject matter.

Reference will now be made to certain embodiments consistent with the present disclosure, examples of which are illustrated in the accompanying drawings. Wherever possible, the same reference numbers are used throughout the drawings to refer to the same or like parts.

The present disclosure describes systems and methods for prioritizing user reactions to content for response on a social-media platform.

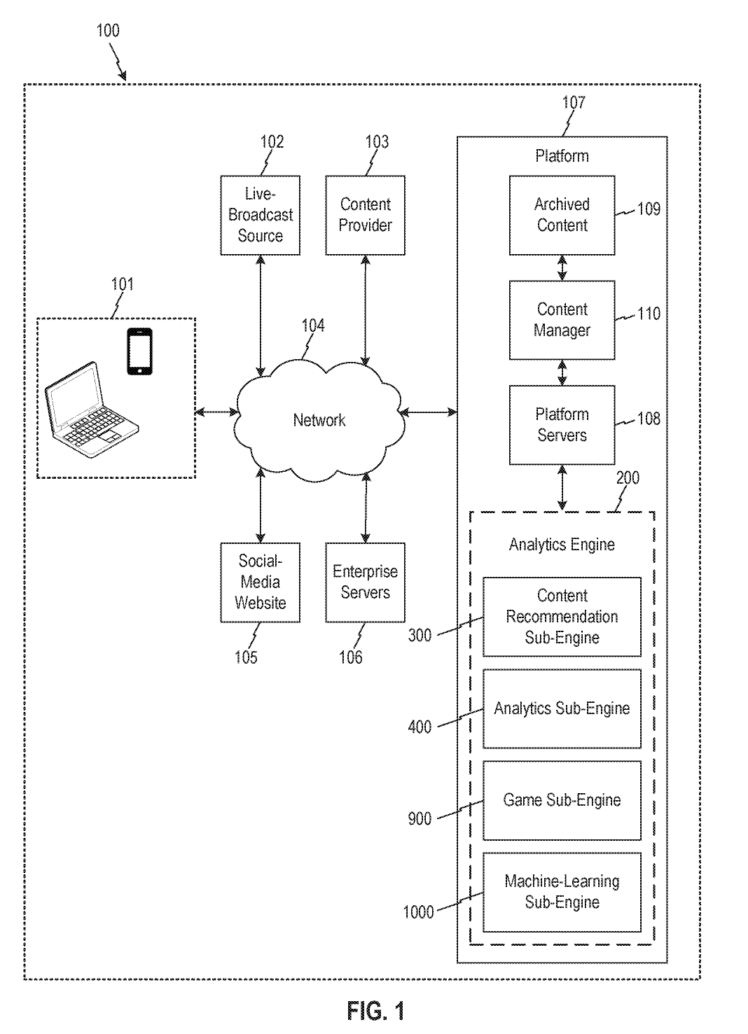

FIG. 1 illustrates an exemplary system environment 100 in which a multimodal social-media data analytics and engagement platform 107 (“platform 107”) may be implemented for performing social-media data analysis, facilitating social-media engagement, and prioritizing user reactions to content for response on platform 107. System environment 100 may comprise a network of users interacting using platform 107. System environment 100 may comprise one or more user computing systems 101. User computing systems 101 may be operatively connected via network 104. Network 104 may be, for example, a digital network such as a cloud-computing network. Network 104 may be a network comprising the Internet of Things, which may provide object-to-object connectivity between multiple computing devices that may communicate in a wired or wireless fashion. Such objects may include sensors and/or actuators embedded into devices that may act as sources for data. User computing systems 101 may be, for example, computing, mobile, and/or wearable devices. User computing systems 101 may comprise one or more processors, one or more memories, one or more displays, one or more sensors, and/or one or more input devices, such as keyboards, mice, touchscreens, or pointing devices such as digital pens, cameras, and/or microphones. In some embodiments, input devices for capturing other senses, such as smell or touch, may be used. Sensors may include, for example, location sensors, global positioning system (GPS) sensors, and/or other sensors.

“Social media” may comprise electronically stored information that users send or make available to other users for the purpose of interacting with other users in a social or professional context. Such media can comprise, for example, directed messages, status messages, broadcast messages, audio files, image files, and/or video files. Social media may be provided to users by platform 107. Social media may be provided by one or more systems operatively connected to network 104. For example, social media may be generated by a user via user computing systems 101. System environment 100 may comprise one or more content providers, such as a live-broadcast source 102, a social-media website 105, or another type of content provider 103. Live-broadcast source 102 may transmit social media in a continuous stream of data to numerous recipients simultaneously. The stream of data from live-broadcast source 102 may be played or viewed substantially as it arrives over network 104 in real time. Content provider 103 may provide on-demand media in response to a user request. Social-media website 105 may be a website that facilitates the exchange of social media between users. In some embodiments, system environment 100 may comprise one or more enterprise servers 106. Platform 107 may be used to store data pertaining to a user's interactions with software or data on enterprise servers 106, such as interactions with a corporate intranet or a corporate email account. Content may be shared with users over platform 107 over a virtual channel that is administered by, for example, a channel administrator. The channel may provide a collection of content to viewers. The content to be provided on the channel may be selected by the channel administrator. The channel administrator may collect data on users who view the content and may collect data pertaining to the viewing of the content. The channel administrator or another person or entity may receive reactions from users to the content that users view on the channel. The channel administrator or another person or entity may respond to the reactions. In certain embodiments, the channel administrator may be any person, people, entity, or entities that respond to or analyze the reactions. A channel administrator may be a content provider, such as content provider 103. A channel administrator may be anyone who administers content on a virtual channel on platform 107. A channel administrator may be an owner of a virtual channel on platform 107. A channel administrator may be any person, people, or entity that provides information or preferences used to prioritize user reactions.

As shown in FIG. 1, platform 107 may comprise one or more platform servers 108, a content management system 110 (“content manager 110”), archived content 109, and/or a multimodal analytics engine 200 (“analytics engine 200”). Platform servers 108 may comprise hardware architecture and a software framework to allow software applications to run, including, but not limited to, operating systems, programming languages, and user interfaces. The software framework may be foundational code and/or one or more software libraries that provide standardized functionality. Platform servers 108 may be used to execute or store software for implementing platform 107. Platform 107 may comprise archived content 109 that is preserved for long-term data storage. Archived content 109 may be stored on one or more databases (not shown). In certain embodiments, one or more of the databases may be remote from platform servers 108 and accessed by platform 107 via network 104. Content manager 110 may be used to add, modify, and/or remove content and access to content, such as documents, slideshows, audio, and video. Analytics engine 200 may be self-contained software that analyzes interactions between users. Analytics engine 200 may be externally controlled by one or more components within platform 107. Analytics engine 200 may comprise one or more sub-engines, such as content recommendation sub-engine 300, multimodal sentiment and behavioral analytics sub-engine 400 (“analytics sub-engine 400”), game sub-engine 900, and machine learning sub-engine 1000.

A user operating a user computing system 101 may connect to platform 107 and view, edit, comment on, react to, or otherwise interact with social media via network 104. The user may, for example, view and react to a live broadcast streamed from live-broadcast source 102, on-demand content provided by content provider 103, content on social-media websites 105, and/or content from enterprise 106. The user's reaction may be generated in the form of, for example, video, audio, emoji, image, or text data. Reactions may be analyzed by platform 107 using analytics engine 200. Content, such as video or images, may be archived and retrieved using, for example, content management system 110 and stored as archived content 109. The content archived may be associated with reactions to the content. For example, reaction data to the content may contain metadata describing the content the reaction was generated to and the time within the content the reaction was generated (e.g., two minutes into a video file). In some embodiments, the content and the corresponding reactions to the content may be archived. Software for archiving and retrieving content may reside on one or more platform servers 108. One or more sub-engines within analytics engine 200 may work independently or collectively to determine which content to target or recommend to a specific user. One or more sub-engines within analytics engine 200 may work independently or collectively to analyze user-generated video, audio, text, emoji, and behavioral data. One or more sub-engines within analytics engine 200 may work independently or collectively to create a game-application or reward environment for the user of the platform 107. One or more sub-engines within analytics engine 200 may work independently or collectively facilitate machine-learning for determining which content to target or recommend to a specific user; for analyzing user-generated video, audio, text, emoji, and behavioral data; and for creating a game-application or reward environment.

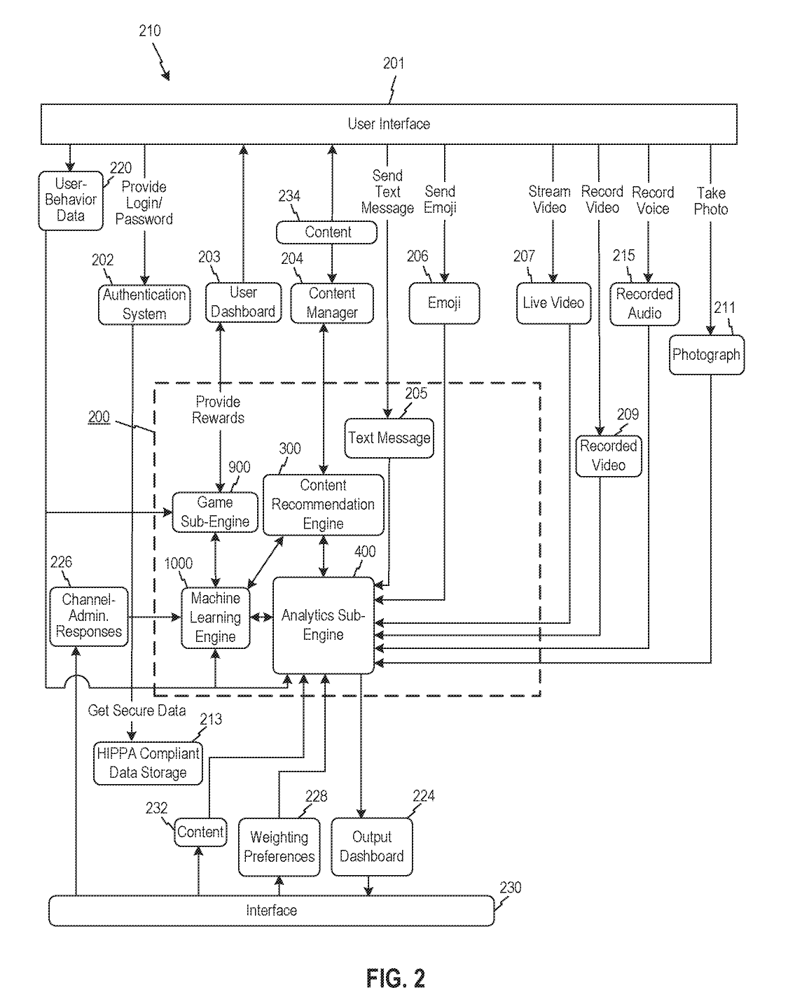

FIG. 2 illustrates an exemplary data-flow diagram 210 demonstrating the operation of analytics engine 200. Analytics engine 200 may comprise one or more software modules that may be located on one device or distributed across multiple devices. For example, one or more modules may be located on a user mobile device, while other modules may be located at a server. Analytics engine 200 may operate on various data generated or viewed by a user. The data may be generated or viewed by a user through a user interface 201. User interface 201 may be, for example, a graphical user interface through which the user views content and provides data. In some embodiments, user interface 201 may be an input system by which the user can indicate an action or a set of instructions to execute on platform 107. Actions may include, for example, selecting content to view, selecting an emoji in response to viewing content, and/or providing a series of textual communications such as text messages. In some embodiments, user interface 201 may comprise a device that registers or recognizes user input, such as biometric instruments that collect user biometric data. User interface 201 may, in certain embodiments, allow the user to access a user dashboard 203. User dashboard 203 may provide the user with various information about his or her use of platform 107, such as status, points, rewards, interests, video trends, recommended content, social-media use history, and sentiment and behavioral analytics pertaining to the user and the user's reactions to viewed content.

In some embodiments, platform 107 may comprise a user manager authentication system 202 (“authentication system 200”) that handles, for example, user login and authentication. Authentication system 202 may authenticate users based on user-provided information, such as login, password, and/or biometric data. Authentication system 202 may hand off authentication tokens and can be connected to user computing systems 101 using, for example, a lightweight directory access protocol (LDAP) or the like. Authentication system 202 may be used to verify or authenticate a login by employees or other authorized users. In an enterprise environment, the data collected and analyzed may be associated with an employee or other authorized user of the enterprise system. In certain embodiments, such as in a healthcare context, the authentication system 202 may collect or use sensitive personal data, or data subject to regulations governing privacy, such as the Health Insurance Portability and Accountability Act of 1996 (HIPAA). Data subject to HIPAA may be stored in a HIPAA-compliant data storage 213. HIPAA-compliant data storage 213 may securely and separately manage user data (e.g., health data or other personally identifiable information). Data collected by authentication system 202 and data stored in HIPAA-compliant data storage 213. Data collected by authentication system 202 and data stored in HIPAA-compliant data storage 213 may be used to separate users into groups based on criteria of interest to the channel administrator (e.g., to the person providing content being viewed). For example, users may be separated into groups by age when platform 107 displays to the channel administrator all users over the age of 35 who watched a particular video hosted on the channel administrator's virtual channel. Data used to separate users into groups may be provided by the user when the user begins using platform 107. Data used to separate users into groups may be collected by platform 107 after observing user behavior on platform 107 (e.g., how many videos they watch per day). User data may be stored collectively as a user profile.

A user may discover and/or view content 234 presented by content manager 204 over user interface 201. Content 234, or a recommendation to view certain content, may be proactively pushed to a user by content recommendation sub-engine 300 based on information known about the user or the user's prior actions. Content recommendation sub-engine 300 may analyze metadata describing available content substantively (e.g., “film about sports”) and describing the content data itself (e.g., “four-minute long video file”). Content recommendation sub-engine 300 may analyze user profiles. User profiles may contain information about, for example, topics the user may be interested in (e.g., sports) and user behavior (e.g., unlikely to watch videos longer than 5 minutes in length). Based on the analysis of user profiles and available content, content recommendation sub-engine 300 may recommend that a user view certain content. For example, content recommendation sub-engine 300 may recommend that a user with a profile indicating an interest in sports and only a small chance of watching a video longer than 5 minutes in length watch a film about sports that is contained in a four-minute-long video file. In some embodiments, content recommendation sub-engine 300 may use machine-learning features of machine-learning sub-engine 1000 to generate recommendations. Machine-learning sub-engine 1000 may use data on user behaviors on platform 107 (e.g., historical viewing activity) to improve the accuracy with which content recommendation sub-engine 300 determines what types of content would be of greatest interest to the user.

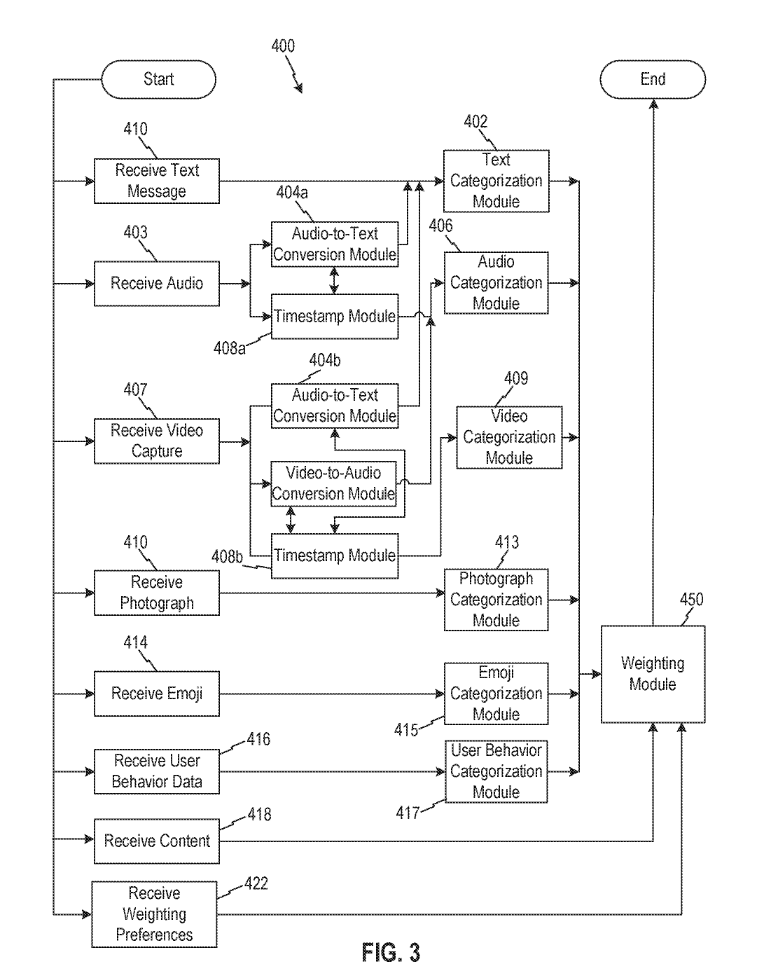

When a user views the recommended content, the user's reaction to the viewed content may be captured and scored by analytics sub-engine 400 according to a user-sentiment scale. Analytics sub-engine 400 is further described detail with respect to FIG. 3. In certain embodiments, machine-learning sub-engine 1000 may receive data generated by the user's reaction and the analysis of the data from analytics sub-engine 400. Machine-learning sub-engine 1000 may use the user's reaction data to improve the accuracy with which analytics sub-engine 400 scores the user's reactions (e.g., by assigning a negative metric to a word present in a text message that previously had a positive metric assigned to it).

As discussed with respect to FIG. 1, content may be hosted by a virtual channel on platform 107. The channel may be administered by, for example, a channel administrator. Platform 107 may display a report (e.g., “output dashboard 224”) comprising an aggregate metric indicating overall user sentiment towards content hosted by the channel. Platform 107 may display a report comprising a map or table that breaks down users' sentiments towards content hosted by the channel by the location of the users or by other criteria (e.g., user age, interests, or number of posts). Platform 107 may display a report to the channel administrator comprising a list of user reactions the channel administrator should respond to in order to make the maximum impact on overall user sentiment associated with particular content or a particular section of content. Such report may have user reactions to viewed content prioritized or ranked such that a response to the higher- prioritized or higher-ranked user reactions would have the greatest impact on overall user sentiment associated with the content. In some embodiments, platform 107 may display a report to the channel administrator comprising a list of user reactions the channel administrator may respond to in order to make the maximum impact on the channel's overall user-sentiment metric. Platform 107 may use machine-learning sub-engine 1000 to improve the accuracy with which analytics sub-engine 400 determines which reactions, if responded to, would maximize the impact on the channel's or the content's overall sentiment metric. For example, machine-learning sub-engine 1000 may monitor whether overall user sentiment towards particular content changes as expected if the channel administrator responds to reactions previously prioritized highly by the analytics sub-engine 400. For this analysis, machine-learning sub-engine 1000 may monitor responses 226 by, for example, the channel administrator. In some embodiments, platform 107 may display a report to the channel administrator or to any person or entity wishing to collect and use similar data. The report may comprise a list of user reactions the channel administrator, a person, or an entity may be most interested in responding to as determined from information provided by a channel administrator, another person, or another entity. Platform 107 may use machine-learning sub-engine 1000 to improve the accuracy with which analytics sub-engine 400 determines which reactions the channel administrator is most interested in responding to. For example, machine-learning sub-engine 1000 may monitor what types of reactions (e.g., from users over the age of 35) the channel administrator responds to. In the example of the channel administrator being interested in user ages, analytics sub-engine 400 may place heavier emphasis on the age of users posting reactions when determining which reactions would be of most interest to the channel administrator.

When using platform 107, the user may express reactions to the viewed content in a variety of ways. A user may express a reaction by sending a text message 205. Text message 205 may, in some cases, be overlaid onto the content. For example, text message 205 may be overlaid onto a slideshow or video presentation such that text message 205 is a real-time reflection of the user's impressions of (e.g., a reaction to) the content at a particular section of the content. Reactions of the users may be captured with a timecode that synchronizes the captured user reaction with other actions being performed on platform 107 by reacting user or other users. For example, text message 205 by a user may be associated with a timecode that associates text message 205 with a location in a slideshow or video presentation that the user may be viewing when or around the time that the user sent text message 205. The timecode may be stored as metadata associated with text message 205. In some embodiments, for example, enterprise employees may be viewing a sales-department presentation with other employees and may be asked by their employers (e.g., the channel administrators) to interact with each other while viewing the presentation, such as by sending text messages. Employees may be asked to register their reactions to certain topics, product introductions, or sales strategies by sending their responses as, for example, text messages in real-time to the enterprise. Text message 205 or other user reactions and the corresponding timecode data may be stored in one or more databases (not shown). The content may later be played back and text message 205 simultaneously displayed based on its timestamp. Platform 107 may archive text message 205 and corresponding timestamp data. Text message 205 with timestamp data may be analyzed by analytics sub-engine 400, discussed below with respect to FIG. 3.

A user may express a reaction by, for example, selecting and sending an emoji 206. Emoji 206 may be a small digital image or icon used to express an idea or emotion with a value along an emotion scale. Emoji 206 may be assigned an emotional sentiment metric within a positive to negative numeric scale. A “thumbs up” graphic, “clapping hands”, or smiley face graphic, for example, may be used to indicate the user likes the content or a positive emotion, while a “thumbs down” or “angry” graphic may be used to indicate displeasure or disagreement or a negative emotion. Other examples of emojis are neutral faces. Emoji 206 may be overlaid over the viewed content such that emoji 206 appears at the portion of the content viewed when emoji 206 was selected by the user. User selection of emoji 206 may be captured with a timecode of the content. Emoji 206 may be matched to the audio and visual content within a certain response time period. The user selection of emoji 206 may be analyzed by analytics sub-engine 400. Platform 107 may offer capabilities for processing emoji 206 that are similar to those described with respect to text message 205.

Users on platform 107 may respond to content via live video chat 207. Live video chat 207 data may travel through one or more platform servers 108. Platform 107 may archive live video chat 207 and the content live video chat 207 pertains to or is a reaction to. Live video chat 207 and the content may be analyzed by analytics sub-engine 400. Platform 107 may offer capabilities for processing live video chat 207 that are similar to those described with respect to text message 205.

Users on platform 107 may respond to content by recording a video 209. Recorded video 209 may travel through one or more platform servers 108. Platform 107 may archive recorded video 209 and the content video 209 pertains to or is a reaction to. Recorded video 209 and the content may be analyzed by analytics sub-engine 400. Platform 107 may offer capabilities for processing recorded video 209 that are similar to those described with respect to text message 205.

Users on platform 107 may respond to content by recording audio 215. Recorded audio 215 may travel through one or more platform servers 108. Platform 107 may archive recorded audio 215 and the content audio 215 pertains to or is a reaction to. Recorded audio 215 and the content may be analyzed by analytics sub-engine 400. Platform 107 may offer capabilities for processing recorded audio 215 that are similar to those described with respect to text message 205.

Users on platform 107 may respond to content by taking a photograph 211. Photograph 211 may travel through one or more platform servers 108. Platform 107 may archive photograph 211 and the content photograph 211 pertains to or is a reaction to. Photograph 211 and the content may be analyzed by analytics sub-engine 400. Platform 107 may offer capabilities for processing photograph 211 that are similar to those described with respect to text message 205.

User-behavior data 220 may be collected by platform 107. User-behavior data may include information about what a user does at a given time, such as how many internet-browsing windows they have open, what volume (e.g., loudness) they are watching content at, the amount of content they are viewing per a unit of time, the length of the average content the user views, what formats the user views content in (e.g., photograph, video, or audio), number and type of emojis sent, number of text messages posted, percent of videos viewed to completion or other viewing statistics, and/or number of emails answered while viewing the video.

Game sub-engine 900 may receive user-behavior data and create games or game features based on the results to encourage user behavior. The games or game features may comprise a reward system to encourage particular future user behavior. For example, an enterprise may wish to encourage employees to participate in a company wellness program. In this example, content recommendation sub-engine 300 may recommend wellness videos to users. Users may receive points or other rewards from game sub-engine 900 for viewing the recommended wellness videos. A user may receive points or other rewards from game sub-engine 900 for uploading a video showing the user exercising. Rewards and points awarded by game sub-engine 900 may vary from user to user as platform 107 learns the users' behavioral responses to rewards using machine-learning sub-engine 1000.

An interface 230 may allow a platform user (e.g., a channel administrator) to, for example, view output dashboard 224, set weighting preferences 228, provide content 232, and provide responses 226 to reactions. Content 232 may be imparted with various metadata by platform 107. For example, content metadata may comprise the length of a video, the number of initial views, the number of complete views, views-to-date, number of times the video was shared, number of times the video was referred to on platform 107, or a trending-interest scale. Data for importing into content metadata may be captured at different points in time and the metadata may reflect the captured information at different points in time as well as composite information. For example, metadata associated with a video file may indicate how many users viewed the video at a particular time as well as how many users have viewed the video overall. Weighting preferences 228 may comprise an indication of what characteristics of reactions the channel administrator is most interested in. Such characteristics may comprise, for example, reaction length (e.g., number of words in a text message or duration of a video recording), popularity of a reaction (e.g., how many users indicated agreement with or appreciation of a reaction), the level of user engagement when the user posted a reactions (as determined by analyzing, for example, user-behavior data 220), the veracity of statements in a reaction (as verified by reference to, for example, a third-party database of information such an online encyclopedia), subject of the reaction (e.g., keywords in reactions), and the demographic data or other profile data of the user posting the reaction.

FIG. 3 illustrates an exemplary analytics sub-engine 400 and its operation. Analytics sub-engine 400 may receive user reactions or behavior as data in a variety of formats (as discussed with respect to FIG. 2), assign sentiment metrics or sentiment categories to reactions (e.g., negative sentiment, neutral sentiment, positive sentiment), and assign weights to reactions (i.e., “weight reactions”) according to predefined rules (e.g., weighting preferences 228) and the sentiment metrics and/or categories assigned to the reactions. The predefined rules may be initially set based on, for example, the channel administrator's responses to a questionnaire regarding the types of reactions the channel administrator is interested in seeing. The rules and the method of assigning a sentiment category may change as machine-learning sub-engine 1000 receives feedback from response selections by the channel administrator and changes in overall user sentiment after the channel administrator posts responses. The reactions analyzed may be reactions of an individual user or reactions of multiple users, such as users interacting with each other on platform 107. The reaction data may arrive at analytics sub-engine 400 with corresponding timestamp metadata, as discussed with respect to FIG. 2.

Analytics sub-engine 400 may break down user reactions with their corresponding timestamp metadata into multiple components for categorizing the individual components into sentiment categories or assigning sentiment metrics and determining an overall sentiment metric or category for the entire reaction. Categorization of reactions and their components may occur by assigning a sentiment metric to one or more components of the reaction. For example, a recorded video reaction may be broken up into text, audio, and video components, each component assigned a sentiment category based on its sentiment metric, and an overall sentiment category assigned for the entire reaction based on the sentiment categories assigned to the reaction's components (e.g., by averaging the sentiment metrics assigned to the components). This process may comprise assigning a sentiment metric to the textual component of the reaction, another sentiment metric to the audio component of the reaction, and another sentiment metric to the video component of the reaction. The sentiment metric may be, for example, a number on a −1 to +1 scale. In some embodiments, the reaction components may be assigned a sentiment metric and the reaction may have both an overall sentiment metric and an overall sentiment category assigned to it. The results may be forwarded to a weighting module, such as weighting module 450, to prioritize reactions for the channel administrator to respond to through a weighting process.

If the user-reaction data is formatted as a text message, such as text message 205, the text may be received (401). The text message may be received with timestamp metadata. The timestamped text may be parsed and/or tokenized by text-categorization module 402 and assigned a sentiment metric. The sentiment metric may be on a −1 to +1 scale, with, for example, −1 to −⅓ representing a negative sentiment category, −⅓ to +⅓ representing a neutral sentiment category, and with +⅓ to +1 representing a positive sentiment category. These positive, negative, or neutral sentiment categories may be assigned by text-categorization module 402. In some embodiments, text-categorization module 402 may assign a sentiment metric using sentiment-analysis software, such as the Valence Aware Dictionary and sEntiment Reasoner. The resulting metric or categorization of the reaction may be forwarded to weighting module 450.

If the user-reaction data is formatted as audio, such as recorded audio 215, the audio may be received (403). The audio may be a podcast or other audio containing a voice or other recording. The recording of the audio may be facilitated by platform 107. In one example, a user that views content may engage with another user of platform 107 by posting an audio recording. This recording may be processed through an audio-to-text conversion module 404a. The audio recording may be passed to timestamp module 408a that may provide timestamp data to the text extracted from the audio. The resulting text with timestamp data may be passed to text-categorization module 402 for parsing and assigning a sentiment metric and/or categorizing into sentiment categories. The audio recording may be processed through an audio-categorization module 406 to ascertain vocal inflection, pitch, and other attributes that may be used to determine the user's sentiment. The audio-categorization module 406 may assign a sentiment metric and/or category to the audio component of the reaction. The sentiment metrics of the text and audio components may be combined to create an overall sentiment for the audio-recording reaction. The resulting metric or categorization of the reaction may be forwarded to weighting module 450. In some embodiments, the audio recording may be processed by one of the audio-to-text conversion module 404a or the audio-categorization module 406.

If the user-reaction data is formatted as a video, such as live video 207 or recorded video 209, the video may be received (407). The recording or streaming of the video may be facilitated by platform 107. In one example, an employee may record a video to be viewed by other employees at their company. The recording may be processed through a audio-to-text conversion module 404b. The text derived from the video may be timestamped by timestamp module 408b. The resulting text with timestamp data may be passed to text-categorization module 402 for parsing and assignment of a sentiment metric and/or categorizing into sentiment categories. The recording may be processed through a video-to-audio conversion module 411 to. The audio derived from the video may be timestamped by timestamp module 408b. The resulting audio with timestamp data may be passed to audio categorization module 406 to ascertain vocal inflection, pitch, and other attributes that may be used to determine the user's sentiment. The audio-categorization module 406 may assign a sentiment metric and/or category to the audio component of the reaction. The video data within the video may processed by video-categorization module 409 to ascertain the sentiment of the user who recorded or streamed the video. The video-categorization module 409 may assign a sentiment metric and/or category to the video component of the reaction. The sentiment metrics of the text, audio, and video components may be combined to create an overall sentiment for the video reaction. The resulting metric or categorization of the reaction may be forwarded to weighting module 450.

If the user-reaction data is formatted as a digital photograph, such as photograph 211, the photograph may be received (410). The generation of the photograph may be facilitated by platform 107. In one example, a user may view video content on platform 107 while a camera captures the user's facial expressions and reactions to the viewed content with timestamp data. The photograph may be processed by photograph categorization module 413 to assign a sentiment metric and/or category to the audio component of the reaction. The results may be forwarded to weighting module 450.

If the user-reaction data is formatted as an emoji, such as emoji 206, the emoji may be received (414). In one example, the user may select an emojis to react to content while viewing it on platform 107. When the viewer responds in real time while viewing content, the emoji data may be timestamped and attributed to a time relative to the content being viewed. The timestamped emoji data may be forwarded to emoji categorization module 415 to be assigned a sentiment metric and/or categorized by sentiment type. The results may be forwarded to weighting module 450.

User-behavior data, such as user behavior data 220, may be provided to weighting engine 450. User- behavior data may be received (416). User-behavior data may, for example, be used to determine the level of user engagement on platform 107. User-behavior data may be forwarded to a user-engagement categorization module 417. User-engagement categorization module 417 may assign the user a metric for a level of engagement (e.g., from −1 for low engagement to +1 for high engagement) and put them into a category based on their level of engagement (e.g., low engagement, medium engagement, high engagement). The result may be forwarded to the weighting module 450.

Content, such as content 232 or 234, and associated metadata may be received (418). The content and associated metadata may be passed to weighting module 450. The metadata may describe the content substantively (e.g., “film about sports”) and/or describe the content data itself (e.g., “four-minute long video file”).

Weighting preferences, such as weighting preferences 228, may be received (422). Weighting preferences 228 may be passed to weighting module 450.

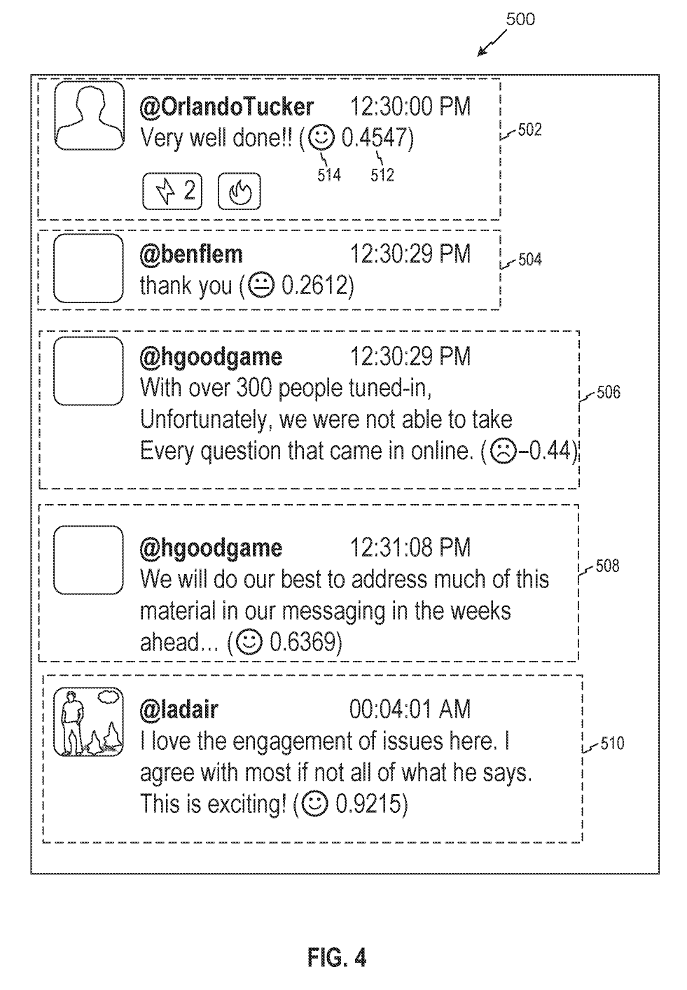

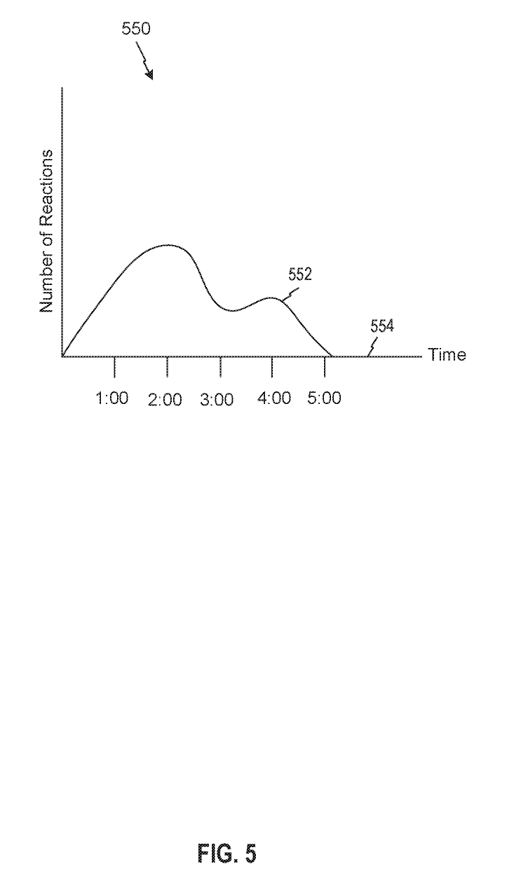

Weighting module 450 may use weighting preferences 228 and sentiment metrics or categorizations of reactions to assign weights to the reactions. A high weight assigned to a reaction may indicate to the channel administrator that the reaction is of the type the channel administrator is interested in and has a strong sentiment associated with it (e.g., a very positive sentiment or a very negative sentiment associated with it). The weights may be passed to output dashboard 224, which may display a number of reactions with the highest weights assigned to them (e.g., the number of reactions the channel administrator requested for display on output dashboard 224 when creating an account on platform 107). For example, output dashboard 224 may provide an exemplary display 500 as illustrated in FIG. 4. Display 500 may comprise reactions 502, 504, 506, 508, and 510. While the reactions in display 500 are text-message reactions, it is to be understood that reactions in other formats may be displayed (e.g., a photograph may be displayed or a link to play an audio or video recording may be displayed). One or more reactions may be displayed with a sentiment metric 512 assigned to the reaction. One or more reactions may be displayed with a representation of a sentiment category 514 assigned to the reaction. For example, a smiling emoji may represent a positive sentiment category, an emoji with a straight line for its mouth may represent a neutral sentiment category, and a frowning emoji may represent a negative sentiment category. In some embodiments, the channel administrator may be displayed an exemplary reaction graph 550 of FIG. 5. Reaction graph 550 may have a curve 552 indicating the number of reactions users on platform 107 had to a piece of content at different locations within the content (indicated on the time axis 554). The channel administrator may select a time on the graph to see the highest weighted reactions from reactions generated at the selected location within the content. For example, the channel administrator may select a two-minute mark on a reaction graph associated with video content. Weighting module 450 may process reactions to the video content with timestamps corresponding to the two-minute mark and display the reactions with the highest weight to the channel administrator. The channel administrator may see the highest weighted reactions in real time as new reactions are being posted by users. The channel administrator may change their preferences in real time to alter how weighting module 450 weights reactions while the reactions are being received and analyzed. For example, halfway through a live video stream, a channel administrator may indicate that he or she wants to weigh reactions from users over the age of 35 more heavily than users under the age of 35. Weighting module 450 may adjust the weights it assigns accordingly. Display 500 may comprise an interface (not shown) through which a channel administrator or other person, people, or entity may respond to a reaction. Such interface may be a selection for the method by which to make a response to a reaction, a selection for making a response to a reaction, and/or an interface for creating a response (e.g., a text box for typing a response).

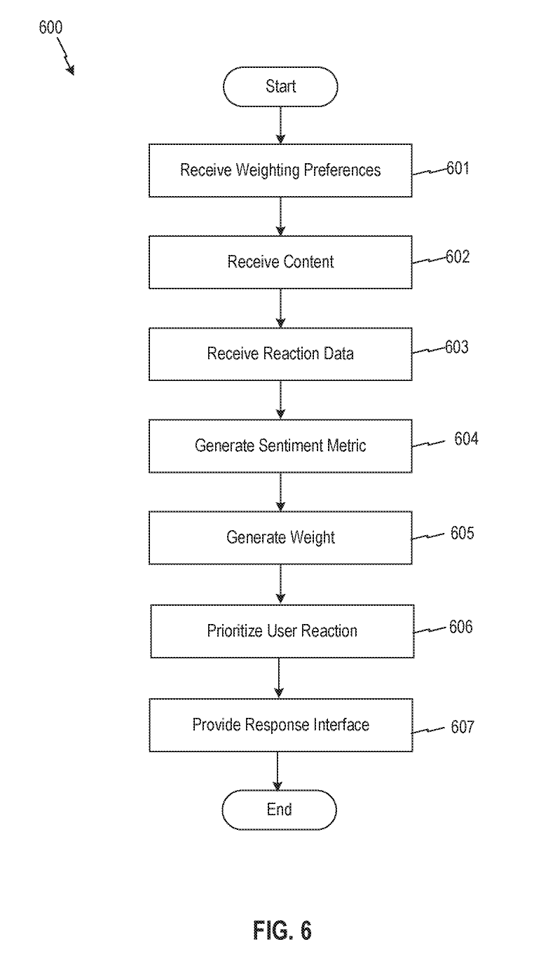

FIG. 6 illustrates an exemplary method 600 for prioritizing user reactions to content on a social-media platform. As shown in FIG. 6, weighting preferences, such as weighting preferences 228, may be received (step 601). Weighting preferences may be used to determine weights that may be assigned to reactions by, for example, module 450. In some embodiments, the weighting preferences may be received from a channel administrator.

In exemplary method 600, content, such as content from a channel administrator, may be received (step 602). In certain embodiments, information about the content, such as content length or subject, may be received instead of or in addition to the content. Such information may be received in the form of content metadata. In certain embodiments, if content metadata or other information about the content is not available or otherwise received, the content may be received and the necessary information derived or extracted. In certain embodiments, if metadata has been previously extracted or derived and provided, it may be unnecessary to receive the content. In certain embodiments, both the content and the content metadata may be received so that the metadata may be verified for accuracy.

In step 603, a plurality of reaction data is received. Each of the reaction data are associated with content, and represents a reaction of a user that viewed, listened to, perceived, or otherwise interacted with the associated content. The reaction data may be associated with a time or location (e.g., a position) within the content, such as the time or location (e.g., position) at which a user experienced the reaction represented by the reaction data.

The reaction data may be used to generate at least one sentiment metric (step 604). The sentiment metric may be, for example, a number between −1 and +1, or other values on a scale from which positivity and negativity can be determined. The sentiment metric may be associated with a sentiment category (e.g., negative sentiment, neutral sentiment, or positive sentiment). The reaction data may be separated into components (e.g., audio component and video component) and generating a sentiment metric associated with at least one of the plurality of reaction data may comprise generating a sentiment metric associated with at least one of the components.

In some embodiments, a weighting preference, such as weighting preference 228, may be received from an entity that wishes to use the output of the method. This could be, for example, the channel administrator, an advertising company, a merchant, or any interested party. If, for example, an entity wants to see reactions from users over the age of 35 to a particular piece of content ranked higher than reactions from other users, entities may be able to so specify. Other weighting preferences that may be specified include, for example, other commonly used demographics, such as age, region of the country, national origin, race, or others. In certain embodiments, the weighting preferences may be filtering preferences, such that reactions not meeting the specified criteria are not displayed. A number of reactions associated with the highest weights may be selected for display based on the weighting preferences by, for example, weighting module 450. The number of reactions displayed may be determined by display preferences that may be set by, for example, the channel administrator. The reactions may be ranked from, for example, highest weighted to lowest weighted. The display may be updated in real time as more reactions are received or as the weighting or display preferences are adjusted by, for example, the channel administrator. Platform 107 may permit responding to reactions. For example, platform 107 may permit a channel administrator or other person or entity to respond to user reactions. The responses may be in text format, audio format, video format, or another format. The user who posted the reaction being responded to may be notified if the channel administrator responds to the user's reaction. Other users who reacted to the content may also receive a notification when the a responds to a user's reaction is submitted. A selection of reactions to respond to may be monitored by, for example, platform 107. The selection may be made by, for example, a channel administrator. The weighting preferences may be adjusted based on the selection by, for example, platform 107. The reactions may be in the form of, for example, emoji data or emoji selection data (e.g., the selection of an emoji from a list of emojis). The weight assigned by, for example, weighting module 450 may be based at least in part on behavior data for a user associated with the reaction data the weight is being assigned to (e.g., assigning a low weight because the user did not watch the video the user is posting a reaction to).

In at least one embodiment, the sentiment metric and at least one of the weighting preferences may be used to generate a weight for some or all of the plurality of reaction data (step 605). The weight may be assigned by, for example, weighting module 450. If reaction data associated with a reaction indicates that the reaction had a relatively high user sentiment associated with it (e.g., +0.99 on a −1 to +1 scale), and if the weighting preference indicates that the person or entity viewing the results is interested in reactions with high user sentiments, a high weight may be assigned to the reaction data. If, however, the preference indicates that the person or entity viewing the results is interested in reactions with low user sentiments, a low weight may be assigned to the reaction data.

The generated weight data for a user reaction may be used to prioritize the user reaction with respect to other user reactions to the associated content based on the weight (step 606). The prioritization may comprise comparing weights assigned to different reactions. For example, reactions with a higher weight may be prioritized higher than reactions with lower weights. The prioritization may be used to determine the order in which reactions may be displayed as an output.

An interface may be provided for responding to the user reaction by, for example, channel-administrator dashboard 224 (step 607). Such interface may be a selection for the method by which to make a response to a reaction, a selection for making a response to a reaction, and/or an interface for creating a response (e.g., a text box for typing a response).

While some examples herein are described with reference to a channel administrator, the system may be used by any entity that wishes to collect and use similar data.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, while illustrative embodiments have been described herein, the scope of any and all embodiments include equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for prioritizing user reactions to content on a social-media platform, the system comprising:
one or more storage mediums storing executable instructions; and
one or more processors configured to execute the instructions, wherein execution of the instructions causes the system to perform a method comprising:
receiving weighting preferences, wherein the weighting preferences may be used to determine weights assigned to user reactions;
receiving a plurality of reaction data associated with content, wherein the reaction data represents user reactions to the associated content;
generating a sentiment metric associated with at least one of the plurality of reaction data, wherein the sentiment metric represents the degree to which a user reaction to the content is positive or negative;
generating a weight based on at least the sentiment metric and at least one of the weighting preferences, wherein the weight is associated with the at least one of the plurality of reaction data;
prioritizing the user reaction for response with respect to other user reactions to the associated content based on the weight; and
providing an interface for responding to the user reaction.

2. The system of claim 1, wherein the method further comprises receiving a display preference and selecting a number of reactions associated with the highest weights for displaying ranked from highest weight to lowest weight, wherein the number is determined by the display preferences and wherein the selection occurs periodically while the display is viewed.

3. The system of claim 1, wherein the method further comprises determining a sentiment category based on a sentiment metric and generating the weight based on at least the sentiment category, wherein the sentiment category represents whether the user reaction is at least one of positive, neutral, or negative.

4. The system of claim 1, wherein the method further comprises separating the reaction data into components and wherein generating a sentiment metric associated with at least one of the plurality of reaction data comprises generating a sentiment metric associated with at least one of the components.

5. The system of claim 1, wherein the reaction data is associated with a time or location within the content at which the user reaction occurred.

6. The system of claim 1, wherein the method further comprises receiving a display preference and selecting a number of reactions associated with the highest weights for display, wherein the number is determined at least by the display preferences.

7. The system of claim 1, wherein the method further comprises monitoring channel-administrator selections of reactions to respond to and adjusting the weighting preferences at least based on the selection.

8. The system of claim 1, wherein the reaction data is the selection of an emoji.

9. The system of claim 1, wherein the weight is further based on behavior data for a user associated with the reaction data.

10. A method for prioritizing user reactions to content on a social-media platform, the method comprising:
receiving weighting preferences, wherein the weighting preferences may be used to determine weights assigned to user reactions;
receiving a plurality of reaction data associated with content, wherein the reaction data represents user reactions to the associated content;
generating a sentiment metric associated with at least one of the plurality of reaction data, wherein the sentiment metric represents the degree to which a user reaction to the content is positive or negative;
generating a weight based on at least the sentiment metric and at least one of the weighting preferences, wherein the weight is associated with the at least one of the plurality of reaction data;
prioritizing the user reaction with respect to other user reactions to the associated content based on the weight; and
providing an interface for responding to the user reaction.

11. The method of claim 10, further comprising receiving a display preference and selecting a number of reactions associated with the highest weights for displaying ranked from highest weight to lowest weight, wherein the number is determined by the display preferences and wherein the selection occurs periodically while the display is viewed.

12. The method of claim 10, further comprising determining a sentiment category based on a sentiment metric and generating the weight based on at least the sentiment category, wherein the sentiment category represents whether the user reaction is at least one of positive, neutral, or negative.

13. The method of claim 10, further comprising separating the reaction data into components and wherein generating a sentiment metric associated with at least one of the plurality of reaction data comprises generating a sentiment metric associated with at least one of the components.

14. The method of claim 10, wherein the reaction data is associated with a time or location within the content at which the user reaction occurred.

15. The method of claim 10, further comprising receiving a display preference selecting a number of reactions associated with the highest weights for display, wherein the number is determined at least by the display preferences.

16. The method of claim 10, further comprising monitoring channel-administrator selections of reactions to respond to and adjusting the weighting preferences at least based on the selection.

17. The method of claim 10, wherein the reaction data is the selection of an emoji.

18. The method of claim 10, wherein the weight is further based on behavior data for a user associated with the reaction data.

19. A non-transitory computer-readable medium storing a set of instructions that are executable by one or more processors to cause the one or more processors to perform a method for prioritizing user reactions to content on a social-media platform, the method comprising:
receiving weighting preferences from a channel administrator, wherein the weighting preferences may be used to determine weights assigned to user reactions;
receiving a plurality of reaction data associated with content, wherein the reaction data represents user reactions to the associated content;
generating a sentiment metric associated with at least one of the plurality of reaction data, wherein the sentiment metric represents the degree to which a user reaction to the content is positive or negative;
generating a weight based on at least the sentiment metric and at least one of the weighting preferences, wherein the weight is associated with the at least one of the plurality of reaction data;
prioritizing the user reaction with respect to other user reactions to the associated content based on the weight; and
providing an interface for responding to the user reaction.

20. The non-transitory computer-readable medium of claim 19, wherein the method further comprises receiving a display preference and selecting a number of reactions associated with the highest weights for displaying ranked from highest weight to lowest weight, wherein the number is determined by the display preferences and wherein the selection occurs periodically while the display is viewed
